(19) United States
(12) Patent Application Publication
(10) Pub. No.: US 2022/0379768 A1
(43) Pub. Date: Dec. 1, 2022

(54) CONTROL DEVICE, POWER SYSTEM AND PROGRAM

(71) Applicant: TOYOTA JIDOSHA KABUSHIKI KAISHA, Toyota-shi (JP)

(72) Inventors: Yusuke HOKI, Mishima-shi (JP); Koseki SUGIYAMA, Sunto-gun (JP); Kumiko KATSUMATA, Susono-shi (JP); Rie YAYABE, Sunto-gun (JP); Shin SAKURADA, Toyota-shi (JP); Tomio YAMANAKA, Nagoya-shi (JP)

(73) Assignee: TOYOTA JIDOSHA KABUSHIKI KAISHA, Toyota-shi (JP)

(21) Appl. No.: 17/719,465

(22) Filed: Apr. 13, 2022

(30) Foreign Application Priority Data
Jun. 1, 2021 (JP) 2021-092615

(51) Int. Cl. B60L 53/67; B60L 55/00; B60L 53/62; B60L 50/61; B60L 53/36; B60L 53/66

(52) U.S. Cl. CPC B60L 53/67; B60L 55/00; B60L 53/62; B60L 50/61; B60L 53/36; B60L 53/665; B60L 2250/16

(57) ABSTRACT

A control device includes an ECU configured to acquire, from each of a plurality of vehicles having a secondary battery and being configured to supply power to the outside, information indicating a charging rate of the secondary battery and vehicle model information, generate arrangement position information by which a arrangement position is allocated to each of the plurality of vehicles in a case where the plurality of vehicles supply the power to the outside in parallel to each other, based on the charging rate of the secondary battery and the vehicle model information, and output the arrangement position information.

### CROSS-REFERENCE TO RELATED APPLICATION

This application claims priority to Japanese Patent Application No. 2021-092615 filed on Jun. 1, 2021, incorporated herein by reference in its entirety.

### BACKGROUND

### 1. Technical Field

The present disclosure relates to a control device, a power system, and a program.

### 2. Description of Related Art

Japanese Unexamined Patent Application Publication No. 2008-236902 (JP 2008-236902 A) discloses an disclosure in which each of a plurality of electric vehicles is electrically connected to an external load outside the vehicle in parallel, and each electric vehicle supplies power to the external load outside the vehicle. In this disclosure, a master vehicle designated from among the electric vehicles receives, from slave vehicles, SOC (state-of-charge) data of each slave vehicle, and determines power distribution when supplying the power from each vehicle to the external load according to the SOC data of the vehicles including the master vehicle itself. The master vehicle calculates a power supply command value for each vehicle based on the determined power distribution, and transmits the command value calculated to each slave vehicle. Each slave vehicle supplies the power to the external load according to the power supply command value.

### SUMMARY

However, the disclosure disclosed in JP 2008-236902 A fails to determine an arrangement of the vehicles when supplying the power to the external load. Therefore, in JP 2008-236902 A, it is expected to be faced with additional issues, such as the burden of replacing a vehicle with a lower remaining battery capacity with a vehicle with a higher remaining battery capacity after the power supply is initiated, or entangled wiring connection between each vehicle and the external load.

The present disclosure provides a control device, a power system, and a program, each of which is capable of presenting a power supply position of each vehicle when each of a plurality of vehicles supplies power to an external load.

A control device according to an aspect of the present disclosure includes a processor configured to acquire, from each of a plurality of vehicles having a secondary battery and being configured to supply power to an outside, information indicating a charging rate of the secondary battery and vehicle model information indicating vehicle models of the vehicles, generate arrangement position information by which a arrangement position is allocated to each of the plurality of vehicles in a case where the plurality of vehicles supply the power to the outside in parallel to each other, based on the charging rate and the vehicle model information, and output the arrangement position information.

With the aspect of the present disclosure, it is possible to present the arrangement position of each vehicle when each of the plurality of vehicles supplies power to the external load.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a schematic configuration example of a power system according to a first embodiment;

FIG. 2 is a block diagram illustrating a functional configuration of a charging-discharging device and a public facility in the power system according to the first embodiment;

FIG. 3 is a block diagram illustrating a functional configuration of a vehicle according to the first embodiment;

FIG. 4 is a flowchart illustrating an outline of an arrangement position presentation process executed by the vehicle according to the first embodiment;

FIG. 5 is a diagram illustrating one example of arrangement position information generated by a generation unit according to the first embodiment;

FIG. 6 is a diagram illustrating one example of power supply plan information of each vehicle, planned by a planning unit according to the first embodiment;

FIG. 7 is a flowchart illustrating an outline of a power supply process executed by the vehicle according to the first embodiment;

FIG. 8 is a diagram illustrating a schematic configuration example of a power system according to a second embodiment;

FIG. 9 is a block diagram illustrating a functional configuration of a server according to the second embodiment; and

FIG. 10 is a flowchart illustrating an outline of an arrangement position presentation process executed by the server according to the second embodiment.

### DETAILED DESCRIPTION OF EMBODIMENTS

The control device, the power system and the program according to the embodiment of the present disclosure will be described hereinbelow with reference to the drawings. The present disclosure is not limited to the following embodiments. The same reference numerals will be assigned to the same parts hereinafter.

### First Embodiment

Outline Configuration of Power System

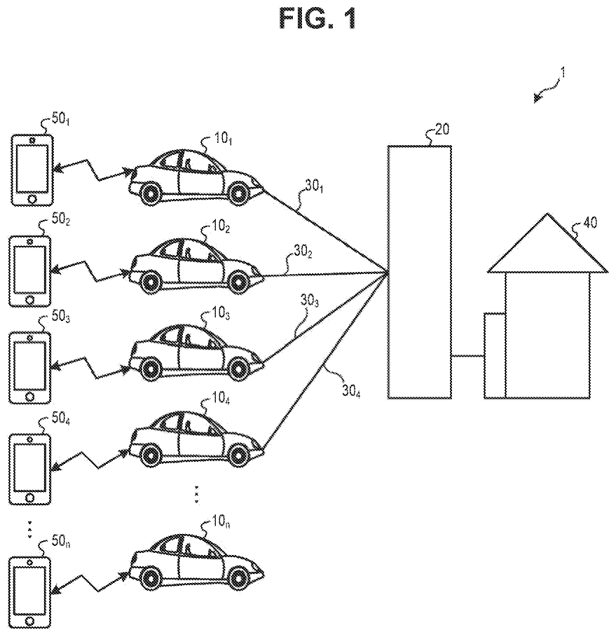

FIG. 1 is a diagram illustrating a schematic configuration example of a power system according to the first embodiment. The power system 1 shown in FIG. 1 includes a plurality of vehicles 10₁ to 10ₙ (n is an integer of 5 or more) (hereinafter, when referring to any of the plurality of vehicles 10₁ to 10ₙ, it will simply be referred to as “vehicle 10”), a charging-discharging (C/D) device 20, a plurality of charging-discharging (C/D) cables 30₁ to 30₄, a public facility 40, and a plurality of communication terminals 50₁ to 50ₙ (m is an integer of 5 or more) (hereinafter, when referring to any of the plurality of communication terminals 50₁ to 50ₘ, it will simply be referred to as “communication terminal 50”). FIG. 1 illustrates a case where the vehicles 10₁ to 10₄ supply (discharge) AC power to the public facility 40. FIG. 1 illustrates a case where the vehicles 10₁ to 10₄ are electrically connected to the single C/D device 20 in parallel, but the present disclosure is not limited thereto. Several (in this case, four) C/D devices 20 may be provided for the vehicles 10₁ to 10₄.

The vehicle 10 is any one of an electric vehicle (EV), a hybrid electric vehicle (EHV), a hybrid vehicle (HV), a plug-in hybrid vehicle (PHV), a plug-in hybrid electric vehicle (PHEV), and a fuel cell electric vehicle (FCEV), which is electrically connected to the C/D device 20 via the C/D cable 30. The vehicle 10 supplies (discharges) the power to an electric load in the public facility 40 via the C/D cable 30 and the C/D device 20. Further, the vehicle 10 charges a secondary battery mounted therein with the power supplied from the public facility 40 via the C/D cable 30 and the C/D device 20. In the first embodiment, the vehicle 10 is any one of the EV, EHV, HV, PHV, PHEV, and FCEV, but is not limited thereto. For example, the disclosure may be applied to an electric motorcycle equipped with a motor and a secondary battery.

The C/D device 20 is provided between the C/D cable 30 and the public facility 40. The C/D device 20 electrically connects each of the vehicles 10₁ to 10₄, which are connected in parallel via the C/D cable 30, with the public facility 40. The C/D device 20 converts the power supplied from the public facility 40 into a predetermined voltage value and supplies the power to each of the vehicles 10₁ to 10₄, which are connected in parallel via the C/D cable 30. The C/D device 20 converts the power supplied from each of the vehicles 10₁ to 10₄, which are connected in parallel via the C/D cable 30, into a predetermined voltage value and supplies the power to the public facility 40.

The public facility 40 receives the power supplied from each of the vehicles 10₁ to 10₄ via the C/D device 20, and also receives commercial grid power from, for example, a power line. Further, the public facility 40 supplies the power supplied to the public facility 40 to the vehicles 10₁ to 10₄ via the C/D device 20.

The communication terminal 50 is communicably connected to the vehicle 10 according to a predetermined communication protocol, and receives various information on the vehicle 10. The communication terminal 50 described hereinbelow is a mobile phone, but the present disclosure is not limited thereto; and the communication terminal 50 may be, for example, a tablet terminal having a display monitor, or a wearable device. Examples of the predetermined communication protocol include Wi-Fi (registered trademark) and Bluetooth (registered trademark).

FIG. 1 illustrates a case where the vehicles 10₁ to 10₄ supply (discharge) the power to the public facility 40, but the number of vehicles 10 is not limited to four. FIG. 1 illustrates a case where the vehicles 10₁ to 10₄ are electrically connected to the single C/D device 20 in parallel. However, several (in this case, four) C/D devices 20 may be respectively provided for the vehicles 10₁ to 10₄.

Functional Configuration of Power System

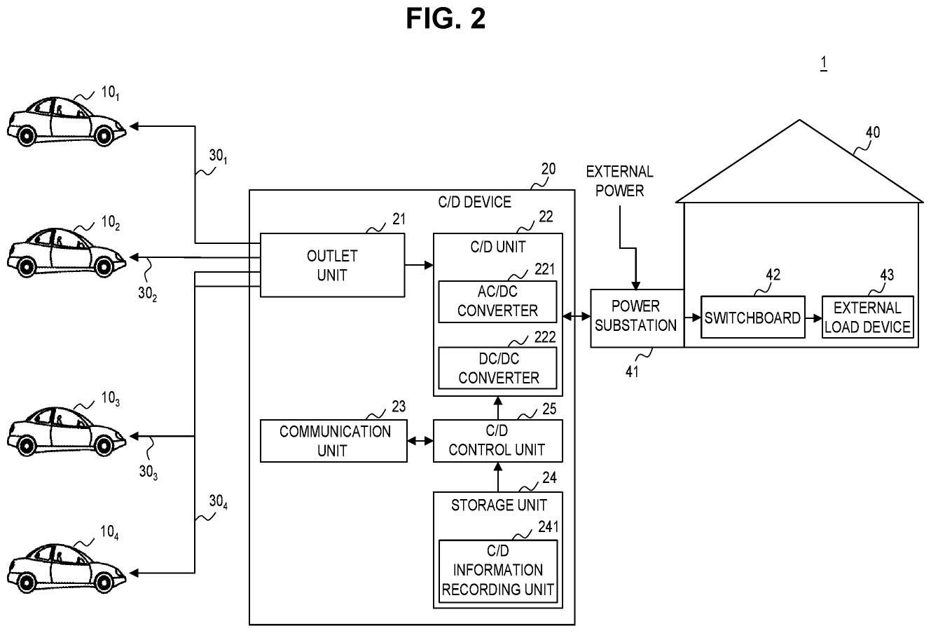

A functional configuration implemented by the power system 1 will be described hereinbelow. FIG. 2 is a block diagram illustrating a functional configuration of the C/D device 20 and the public facility 40 in the power system 1. The detailed functional configuration of the vehicle 10 will be described below.

Functional Configuration of C/D Device

A functional configuration implemented by the C/D device 20 will be described hereinbelow. As shown in FIG. 2, the C/D device 20 includes an outlet unit 21, a charging-discharging (C/D) unit 22, a communication unit 23, a recording unit 24, and a charging-discharging (C/D) control unit 25.

The outlet unit 21 (electric outlet) has one end electrically connected to each plug of the C/D cables 30, and the other end electrically connected to the C/D unit 22 and the communication unit 23. The outlet unit 21 has a plurality of outlets, into each of which the plug of the C/D cable 30 can be inserted.

The C/D unit 22 has one end electrically connected to the outlet unit 21, and the other end electrically connected to a power substation 41 of the public facility 40, which will be described below. The C/D unit 22 supplies the power, which is supplied from the power substation 41 of the public facility 40, to the vehicle 10 via the outlet unit 21 and the C/D cable 30, as controlled by the C/D control unit 25. Further, the C/D unit 22 supplies the power, which is supplied from the vehicle 10, to the power substation 41 via the outlet unit 21 and the C/D cable 30, as controlled by the C/D control unit 25. The C/D unit 22 has as least an AC/DC converter 221 that enables bidirectional conversion of AC and DC power, and a DC/DC converter 222 that enables bidirectional conversion of DC power.

The AC/DC converter 221 converts the AC power supplied from the power substation 41 into DC power and outputs the DC power to the DC/DC converter 222, as controlled by the C/D control unit 25. Further, the AC/DC converter 221 converts the DC power input from the DC/DC converter 222 into AC power and outputs the AC power to the power substation 41, as controlled by the C/D control unit 25.

The DC/DC converter 222 converts the DC power input from the AC/DC converter 221 into the predetermined voltage value and outputs the power to the outlet unit 21, as controlled by the C/D control unit 25. Further, the DC/DC converter 222 converts the DC power input from the outlet unit 21 into the predetermined voltage value and outputs the power to the AC/DC converter 221, as controlled by the C/D control unit 25.

The communication unit 23 receives CAN data of the vehicle 10 and various information on the vehicle 10, which are input via the C/D cable 30 and the outlet unit 21, and outputs the various information received to the C/D control unit 25. Further, the communication unit 23 transmits various information acquired from the C/D control unit 25 to the vehicle 10 via the C/D cable 30 and the outlet unit 21.

The recording unit 24 records various information on the C/D device 20. Further, the recording unit 24 has a charging-discharging (C/D) information recording unit 241 for recording charging-discharging (C/D) information. The C/D information includes, for example, the number of outlets provided in the outlet unit 21, the number of C/D cables 30 accommodated in the C/D device 20, a grade of the C/D cable 30, a length of the C/D cable 30, specification information of the outlet, and a voltage value that can be supplied. The recording unit 24 includes, for example, a dynamic random access memory (DRAM), a read only memory (ROM), a flash memory, a hard disk drive (HDD), or a solid state drive (SSD).

The C/D control unit 25 includes a memory and a processor having hardware such as a digital signal processor (DSP), a field-programmable gate array (FPGA), or a central processing unit (CPU). The C/D control unit 25 controls each unit constituting the C/D device 20.

Functional Configuration of Public Facility

Next, a functional configuration implemented by the public facility 40 will be described. The public facility 40 includes the power substation 41, a switchboard 42, and an external load device 43.

The power substation 41 receives external power transmitted from the outside, converts the received external power into, for example, the predetermined voltage value, and supplies the power to the switchboard 42 and the C/D device 20. Further, the power substation 41 receives the power supplied (discharged) from the vehicle 10 via the C/D device 20, and supplies the received power to the switchboard 42.

The switchboard 42 is electrically connected to an outlet (not shown) provided in the public facility 40, and distributes the AC power supplied from the power substation 41 to the external load device 43.

The external load device 43 is a power-consuming instrument. In particular, the external load device 43 is, for example, a lighting fixture, a storage battery, an elevator, a home appliance, or a communication device.

Functional Configuration of Vehicle

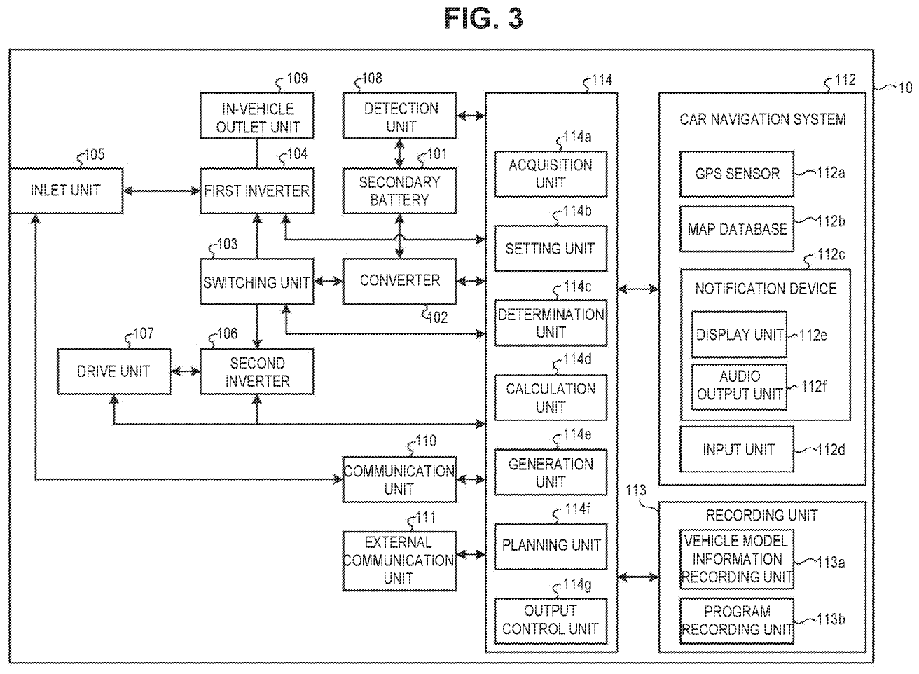

Next, a functional configuration of the vehicle 10 will be described. FIG. 3 is a block diagram illustrating the functional configuration of the vehicle 10. The vehicle 10 will be described hereinbelow as having a mechanism configuration of an EV, among an EV, HEV, HV, PHV, PHEV, and FCEV, provided that, however, the vehicle 10 would have the same configuration if it were an REV, HV, PHV, PHEV, or FCEV.

As shown in FIG. 3, the vehicle 10 includes a secondary battery 101, a converter 102, a switching unit 103, a first inverter 104, an inlet unit 105, a second inverter 106, a drive unit 107, a detection unit 108, an in-vehicle outlet unit 109, a communication unit 110, an external communication unit 111, a car navigation system 112, a recording unit 113, and an electronic control unit (ECU) 114.

The secondary battery 101 may include, for example, a rechargeable storage battery such as a nickel-hydrogen battery or a lithium ion battery, or alternatively, a power storage element such as an electric double layer capacitor. The secondary battery 101 can be charged and discharged by the converter 102, and stores high-voltage DC power.

The converter 102 has one end electrically connected to the secondary battery 101, and the other end electrically connected to one of the first inverter 104 and the second inverter 106 via the switching unit 103. The converter 102 charges and discharges the secondary battery 101 as controlled by the ECU 114. In a case where the secondary battery 101 is charged, the converter 102 steps down the DC power supplied from the outside via the first inverter 104, the inlet unit 105, and the switching unit 103 to a predetermined voltage, and supplies the step-down charging current to the secondary battery 101. On the other hand, in a case where the secondary battery 101 is discharged, the converter 102 boosts a voltage of the DC power supplied from the secondary battery 101, and supplies the boosted discharging current to the second inverter 106 via the switching unit 103.

The switching unit 103 has one end electrically connected to the converter 102, and the other end electrically connected to one of the first inverter 104 and the second inverter 106. The switching unit 103 electrically connects the converter 102 to one of the first inverter 104 and the second inverter 106, as controlled by the ECU 114. The switching unit 103 may include, for example, a mechanical relay or a semiconductor switch.

The first inverter 104 has one end electrically connected to the switching unit 103, and the other end electrically connected to the inlet unit 105 or the in-vehicle outlet unit 109. The first inverter 104 converts the discharging power (DC power) supplied from the secondary battery 101 via the switching unit 103 and the converter 102 into AC power, and then supplies the AC power to the inlet unit 105, as controlled by the ECU 114. In particular, the first inverter 104 supplies the AC power to the public facility 40 via the inlet unit 105 and the C/D cable 30, as controlled by the ECU 114. The first inverter 104 may include, for example, a single-phase inverter circuit to correspond to a form of the power used in the public facility 40.

The inlet unit 105 has one end electrically connected to the first inverter 104. The C/D cable 30 is detachably connected to the inlet unit 105. The inlet unit 105 supplies the AC power supplied from the C/D device 20 to the first inverter 104 via the C/D cable 30, and outputs various information including, for example, a control signal supplied from the C/D device 20 to the communication unit 110. Further, the inlet unit 105 supplies the AC power supplied from the first inverter 104 to the C/D device 20 via the C/D cable 30, and outputs various information including, for example, a control signal supplied from the ECU 114, which is input via the communication unit 110, to the C/D device 20.

The second inverter 106 converts the discharging power (DC power) supplied from the secondary battery 101 via the switching unit 103 and the converter 102 into AC power, and then supplies the AC power to the drive unit 107, as controlled by the ECU 114. Further, the second inverter 106 converts the AC power generated by the drive unit 107 into DC power upon regenerative braking of the vehicle 10, and supplies the DC power to the secondary battery 101 via the switching unit 103 and the converter 102, as controlled by the ECU 114. The second inverter 106 may include, for example, a three-phase inverter circuit such as a bridge circuit with three-phase switching elements.

The drive unit 107 receives the AC power supplied from the second inverter 106 to generate rotational driving force, and receives rotational driving force from the outside to generate the AC power, as controlled by the ECU 114. The drive unit 107 may include, for example, a three-phase AC rotating electrical machine having a rotor with a permanent magnet embedded therein. An output shaft of the drive unit 107 is transmitted to wheels (not shown) via a power splitter (not shown) and a drive shaft.

The detection unit 108 detects a remaining capacity (SOC), temperature, state-of-health (SOH), voltage value, and current value of the secondary battery 101, and outputs the detection results to the ECU 114. The detection unit 108 may include, for example, an ammeter, a voltmeter, and a temperature sensor.

The in-vehicle outlet unit 109 is electrically connected to the first inverter 104. The in-vehicle outlet unit 109 can be connected to a power plug of a general electric appliance, and supplies the AC power supplied from the first inverter 104 to the electric appliance to which the power plug is connected.

The communication unit 110 receives a control signal including various information input from C/D device 20 via the inlet unit 105, and outputs the received control signal to the ECU 114. Further, the communication unit 110 outputs a control signal including, for example, the CAN data input from the ECU 114 to the inlet unit 105. The communication unit 110 may include, for example, a communication module.

The external communication unit 111 transmits various information input from the ECU 114 to the communication terminal 50 according to a predetermined communication protocol, as controlled by the ECU 114. Further, the external communication unit 111 outputs various information received from the communication terminal 50 to the ECU 114. The predetermined communication protocol is at least one of Wi-Fi (registered trademark) and Bluetooth (registered trademark). The external communication unit 111 may include, for example, a wireless communication module.

The car navigation system 112 includes a GPS (Global Positioning System) sensor 112a, a map database 112b, a notification device 112c, and an input unit 112d.

The GPS sensor 112a receives signals from a plurality of GPS satellites or transmission antennas, and calculates a location (longitude and latitude) of the vehicle 10 based on the received signals. The GPS sensor 112a may include, for example, a GPS reception sensor. In the first embodiment, orientation accuracy of the vehicle 10 may be improved by mounting a plurality of GPS sensors 112a.

The map database 112b stores various map data. The map database 112b includes a storage medium such as a hard disk drive (HDD) or a solid state drive (SSD).

The notification device 112c includes a display unit 112e that displays images, maps, videos, and character information, and an audio output unit 112f that generates sounds such as voice and alarm sounds. The display unit 112e includes a display device such as liquid crystal or organic electro luminescence (organic EL) display. The audio output unit 112f may include, for example, a speaker.

The input unit 112d receives input of operations of a user, and outputs to the ECU 114 signals corresponding to the various operations received. The input unit 112d is implemented by, for example, a touchscreen, buttons, switches, and a jog dial.

The car navigation system 112 thus configured superimposes a current location of the vehicle 10 acquired by the GPS sensor 112a on a map corresponding to map data stored in the map database 112b, whereby the user is notified, by the display unit 112e and the audio output unit 112f, of information including a road on which the vehicle 10 is travelling and a travel route to a destination.

The recording unit 113 records various information on the vehicle 10. The recording unit 113 records, for example, the CAN data of the vehicle 10 input from the ECU 114, and data of various processes executed by the ECU 114. The recording unit 113 includes a vehicle model information recording unit 113a related to the vehicle 10 and a program recording unit 113b for recording various programs executed by the vehicle 10. Vehicle model information includes a vehicle model of the vehicle 10, identification information for identifying the vehicle 10, a model year of the vehicle 10, whether it has a power generation function, and information indicating that the vehicle is any one of an EV, HV, PHV, and FCEV. The recording unit 113 may include, for example, a DRAM, a ROM, a flash memory, or a solid state drive (SSD).

The ECU 114 includes a memory and a processor having hardware such as a central processing unit (CPU). The ECU 114 controls operations of units constituting the vehicle 10. The ECU 114 includes an acquisition unit 114a, a setting unit 114b, a determination unit 114c, a calculation unit 114d, a generation unit 114e, a planning unit 114f, and an output control unit 114g. In the first embodiment, the ECU 114 functions as the control device.

The acquisition unit 114a acquires the SOC (charging rate) of the secondary battery 101 from each of the plurality of vehicles 10₁ to 10ₙ via the communication unit 110 or the external communication unit 111. Further, in a case where the vehicle 10 determines whether each vehicle 10 has a power generation function capable of supplying power to the secondary battery 101 based on the vehicle model information, and has the power generation function, the acquisition unit 114a acquires a remaining amount of fossil fuel or hydrogen fuel from the vehicle 10 having the power generation function.

The setting unit 114b sets the vehicle 10 which serves as a master vehicle in a case where the power is supplied (discharged) from each vehicle 10, among of the plurality of vehicles 10₁ to 10ₙ, based on the SOC, the remaining amount of fossil fuel or hydrogen fuel, and the vehicle model information of each vehicle 10, which are acquired by the acquisition unit 114a.

The determination unit 114c determines whether the vehicle 10 is set as the master vehicle 10 by the setting unit 114b. The determination unit 114c determines whether fossil fuel is used in the vehicle 10 having the power generation function capable of supplying power to the secondary battery 101 using the predetermined fuel, based on the vehicle model information acquired by the acquisition unit 114a. Further, the determination unit 114c determines whether the plurality of vehicles 10 are respectively stopped at arrangement positions R₁ to Rₙ, based on the position information of each vehicle 10 acquired by the acquisition unit 114a and arrangement position information generated by the generation unit 114e.

The calculation unit 114d calculates a power supply amount (Wh) that can be supplied from each vehicle 10 to the outside, based on the SOC of the secondary battery 101, the remaining amount of fossil fuel or hydrogen fuel, and the vehicle model information, of each vehicle 10, which are acquired by the acquisition unit 114a.

The generation unit 114e generates the arrangement position information by which an arrangement position is allocated to each of the plurality of vehicles 10₁ to 10ₙ, based on the power supply amount, facility information, and the vehicle model information of each vehicle 10 calculated by the calculation unit 114d. In such a case, the generation unit 114e generates the arrangement position information such that the vehicles 10 whose fuel is a fossil fuel are arranged in order starting in order starting from the outside of an alignment formed by the plurality of vehicles 10₁ to 10ₙ. Further, the generation unit 114e generates the arrangement position information such that the vehicles 10 with a lower power supply amount are arranged in order starting from the outside of the alignment formed by the plurality of vehicles 10₁ to 10ₙ.

The planning unit 114f generates power supply plan information indicating a scheduled supply time of each vehicle 10, based on the arrangement position information generated by the generation unit 114e, as well as the SOC of the secondary battery 101, the remaining amount of fossil fuel or hydrogen fuel, and the vehicle model information, of each vehicle 10, which are acquired by the acquisition unit 114a.

The output control unit 114g outputs the arrangement position information generated by the generation unit 114e and the power supply plan information planned by the planning unit 114f to each vehicle 10, or the communication terminal 50 associated with each vehicle 10, by establishing vehicle-to-vehicle (V2V) communication with each vehicle 10 via the communication unit 110 or the external communication unit 111.

Arrangement Position Presentation Process Executed by Vehicle

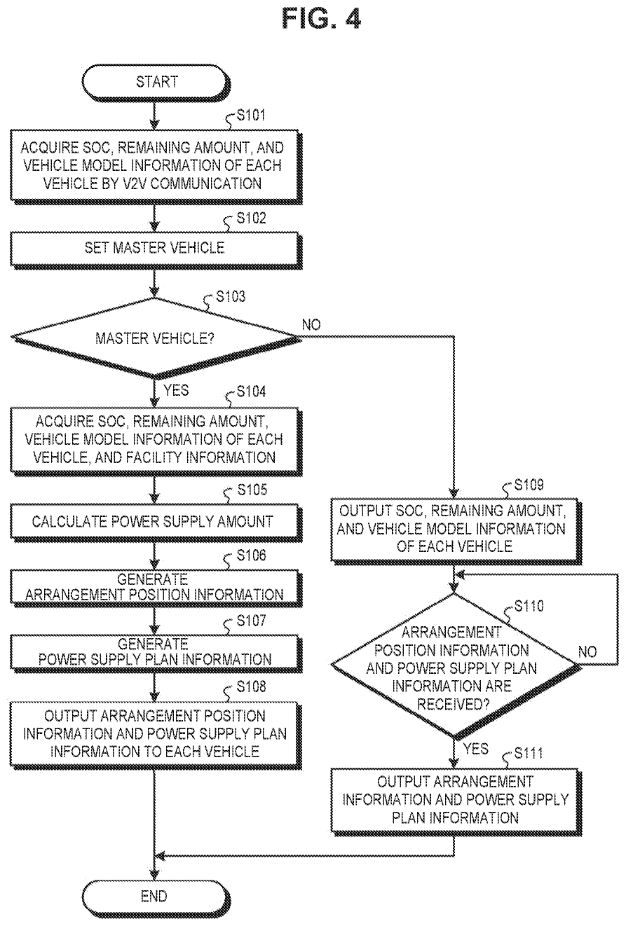

An arrangement position presentation process executed by the vehicle 10 will be described hereinbelow. FIG. 4 is a flowchart illustrating an outline of the arrangement position presentation process executed by the vehicle 10. Hereinbelow, the arrangement position of each vehicle 10 will be presented in a case where the power is supplied to the public facility 40 from the plurality of vehicles 10₁ to 10ₙ, located in a predetermined area centered on, for example, 500 meters×500 meters around the C/D device 20.

As shown in FIG. 4, the acquisition unit 114a acquires the SOC of the secondary battery 101, the remaining amount of fossil fuel or hydrogen fuel, and the vehicle model information, of each vehicle 10, by establishing V2V communication with other vehicles 10 via the external communication unit 111 (step S101).

The setting unit 114b sets the vehicle 10 which serves as a master vehicle (hereinafter referred to as “master vehicle 10”) in a case where the power is discharged from each vehicle 10, among the plurality of vehicles 10, based on the SOC, the remaining amount of fossil fuel or hydrogen fuel, and the vehicle model information of each vehicle 10, which are acquired by the acquisition unit 114a (step S102). In particular, the setting unit 114b selects the EV, FCEV, PHV, and HV, in this order, among the plurality of vehicles 10, based on the SOC, the remaining amount of fossil fuel or hydrogen fuel, and the vehicle model information of each vehicle 10, which are acquired by the acquisition unit 114a; and sets, in a case where there are several vehicles with same class, e.g. several EVs, the vehicle 10 having the highest SOC of the secondary battery 101 as the master vehicle 10, and the other vehicles 10 as slaves vehicles 10 (hereinafter referred to as “slave vehicle 10”).

The determination unit 114c determines whether the vehicle 10 is set as the master vehicle 10 by the setting unit 114b (step S103). In a case where the determination unit 114c determines that the vehicle 10 is set as the master vehicle 10 by the setting unit 114b (step S103: YES), the vehicle 10 proceeds to step S104 described below. On the other hand, in a case where the determination unit 114c determines that the vehicle 10 is not set as the master vehicle 10 by the setting unit 114b (step S103: NO), the vehicle 10 proceeds to step S109 described below.

In step S104, the acquisition unit 114a of the master vehicle 10 acquires the SOC of the secondary battery 101, the remaining amount of fossil fuel or hydrogen fuel, and the vehicle model information, of each vehicle 10, by establishing V2V communication with slave vehicles 10 via the external communication unit 111, and also acquires the facility information from C/D device 20.

The calculation unit 114d of the master vehicle 10 calculates the power supply amount that can be supplied from each vehicle 10 to the outside, based on the SOC of the secondary battery 101, the remaining amount of fossil fuel or hydrogen fuel, and the vehicle model information, of each vehicle 10 (including the master vehicle 10 and the slave vehicles 10), which are acquired by the acquisition unit 114a (step S105).

The generation unit 114e of the master vehicle 10 generates the arrangement position information by which an arrangement position is allocated to each of the plurality of vehicles 10₁ to 10ₙ, based on the power supply amount of each vehicle 10 calculated by the calculation unit 114d of the master vehicle 10, the facility information and the vehicle model information (step S106).

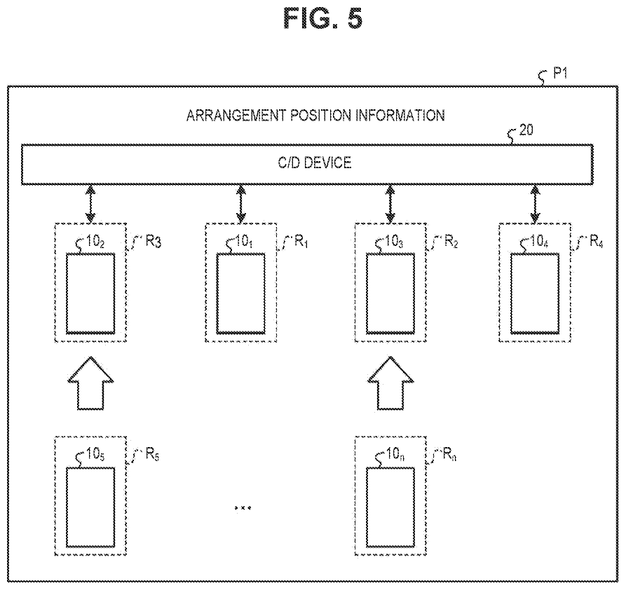

FIG. 5 is a diagram illustrating one example of the arrangement position information generated by the generation unit 114e. In the example shown in FIG. 5, the C/D device 20 has four outlets.

As shown in FIG. 5, the generation unit 114e of the master vehicle 10 generates arrangement position information P1 by which the vehicles 10, e.g. EVs, are allocated to the arrangement positions R₁ to Rₙ in order starting from a center of an alignment in which the plurality of vehicles 10₁ to 10ₙ supply the power to the outside in parallel to each other, based on the vehicle model information of each vehicle 10. Further, the generation unit 114e generates the arrangement position information P1 by which an arrangement position is allocated to each vehicle 10 in the order starting from the vehicle 10 having the largest power supply amount, from the center to the outside of the alignment for supplying the power to the outside, based on the power supply amount that each vehicle 10 can supply. For example, in a case where the power supply amount is large in the order of the vehicle 10₁ (master vehicle 10), the vehicle 10₃, the vehicle 10₂, and the vehicle 10₄, the generation unit 114e generates the arrangement position information by which the vehicle 10₁ (master vehicle 10) is allocated to the arrangement position R₁, the vehicle 10₃ to the arrangement position R₂, the vehicle 10₂ to the arrangement position R₃, and the vehicle 10₄ to the arrangement position R₄. In such a case, as shown in FIG. 5, when the number of vehicles 10 is four, the generation unit 114e generates the arrangement position information P1 by which the vehicles 10 having the power generation function using fossil fuel (e.g. gasoline) (for example, the vehicles 10₂ and 10₄ are HVs or PHVs) are allocated to the arrangement position R₃ and R₄ at each end of a first row.

Further, as shown in FIG. 5, when the number of vehicles 10 is four or more, the generation unit 114e generates the arrangement position information P1 by which the vehicle 10 having the power generation function using fossil fuel (e.g. gasoline) (for example, the HV or PHV) is allocated to the arrangement position R₅, for example, in a second or subsequent row. Consequently, it is possible to prevent carbon monoxide poisoning caused by driving an engine when the power is supplied (discharged) from the vehicle 10 to the C/D device 20. In this case, the generation unit 114e may generate the arrangement position information P1 by adding or highlighting information that can identify the vehicle 10 having the power generation function using fossil fuel, from other vehicles 10. Furthermore, the generation unit 114e may generate the arrangement position information P1 excluding the vehicles 10 having the power generation function using fossil fuel (e.g. gasoline) in a case where it is determined that a place that the vehicle 10 is stopped at cannot be ventilated based on the facility information and the vehicle model information.

Returning to FIG. 4, step S107 and subsequent steps will be described hereinbelow. In step S107, the planning unit 114f of the master vehicle 10 generates the power supply plan information indicating the scheduled supply time allocated to each vehicle 10, based on the arrangement position information generated by the generation unit 114e of the master vehicle 10, as well as the SOC of the secondary battery 101, the remaining amount of fossil fuel or hydrogen fuel, and the vehicle model information, of each vehicle 10, which are acquired by the acquisition unit 114a of the master vehicle 10.

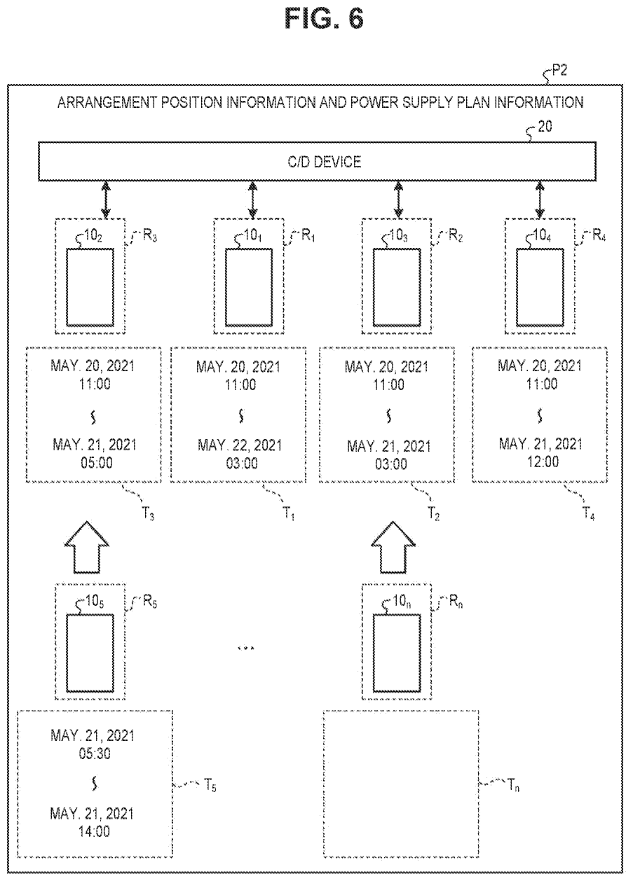

FIG. 6 is a diagram illustrating one example of the power supply plan information of each vehicle 10, planned by the planning unit 114f. In the example shown in FIG. 6, the C/D device 20 has four outlets. In FIG. 6, the power supply plan information planned according to the arrangement position information P1, which is generated by the generation unit 114e, will be described.

As shown in FIG. 6, the planning unit 114f of the master vehicle 10 generates the power supply plan information indicating scheduled supply times T₁ to Tₙ respectively allocated to the vehicles 10, based on the arrangement position information P1 generated by the generation unit 114e of the master vehicle 10, as well as the SOC of the secondary battery 101, the remaining amount of fossil fuel or hydrogen fuel, and the vehicle model information, of each vehicle 10, which are acquired by the acquisition unit 114a of the master vehicle 10. For example, as shown in FIG. 6, the planning unit 114f of the master vehicle 10 generates the power supply plan information that presents the scheduled supply times T₁ to Tₙ, in which a power supply date, a supply start time, and a supply end time are associated with each vehicle 10, near to the arrangement positions R₁ to Rₙ. Consequently, the user can identify the power supply date, the supply start time, and the supply end time of their own vehicle 10.

Returning to FIG. 4, step S108 and subsequent steps will be described hereinbelow. In step S108, the output control unit 114g of the master vehicle 10 outputs the arrangement position information generated by the generation unit 114e of the master vehicle 10 and the power supply plan information planned by the planning unit 114f to slave vehicle 10, or the communication terminal 50 associated with each vehicle 10, by establishing V2V communication with the slave vehicle 10 via the external communication unit 111. In such a case, as shown in FIG. 6, the other vehicle 10 display an arrangement position image P2 for representing the arrangement position information and the power supply plan information of each vehicle 10 on the display unit 112e. Consequently, the user of each vehicle 10 can intuitively understand the arrangement position and the power supply time of their own vehicle. Although the display unit 112e of the vehicle 10 displays the arrangement position image P2 in FIG. 6, the communication terminal 50 associated with each vehicle 10 may be displayed. The vehicle 10 terminates this process after step S108.

In step S109, the output control unit 114g of the slave vehicle 10 outputs the SOC of the secondary battery 101, the remaining amount of fossil fuel or hydrogen fuel, and the vehicle model information, of each vehicle 10, by establishing V2V communication with the master vehicle 10 via the external communication unit 111.

Subsequently, the determination unit 114c of the slave vehicle 10 determines whether the arrangement position information and the power supply plan information have been received from the master vehicle 10 (step S110). In a case where it is determined by the determination unit 114c of the slave vehicle 10 that the arrangement position information and the power supply plan information have been received from the master vehicle 10 (step S110: YES), the slave vehicle 10 proceeds to step S111 described below. On the other hand, in a case where it is determined by the determination unit 114c of the slave vehicle 10 that the arrangement position information and the power supply plan information have not been received from the master vehicle 10 (step S110: NO), the determination unit 114c of the slave vehicle 10 performs this determination repeatedly until the arrangement position information and the power supply plan information are received from the master vehicle 10.

In step S111, the output control unit 114g of the slave vehicle 10 outputs the arrangement position information and the power supply plan information received from the master vehicle 10 to the display unit 112e (see FIG. 6). In such a case, the output control unit 114g of the slave vehicle 10 may output the arrangement position information and the power supply plan information received from the master vehicle 10 to the communication terminal 50 associated with the slave vehicle 10. The vehicle 10 terminates this process after step S111.

Power Supply Process Executed by Vehicle

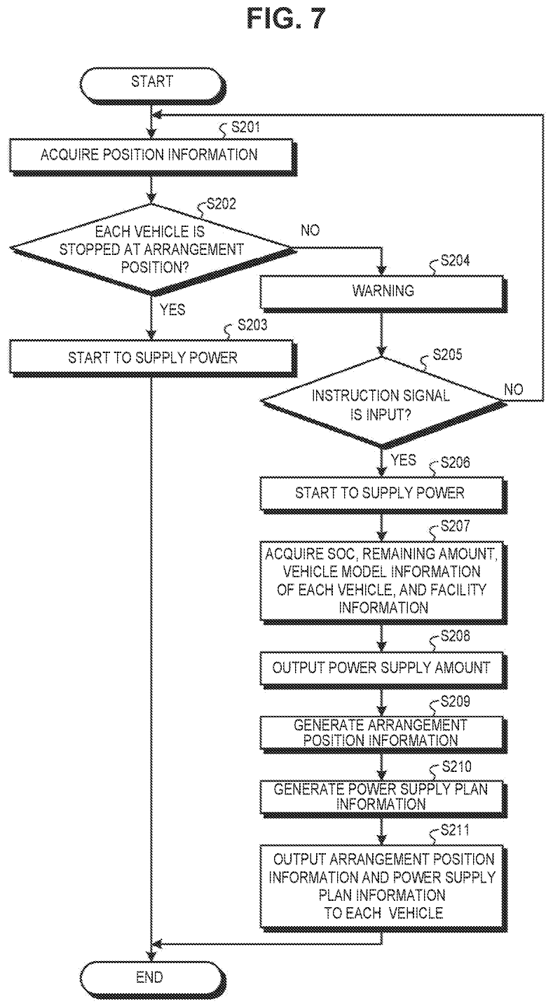

A power supply process executed by the vehicle 10 will be described hereinbelow. FIG. 7 is a flowchart illustrating an outline of the power supply process executed by the vehicle 10. FIG. 7 describes the process executed by the master vehicle 10 among the plurality of vehicles 10. Further, in FIG. 7, processing after the plurality of vehicles 10 respectively stop at the arrangement positions R₁ to Rₙ included in the arrangement position information generated by the generation unit 114e will be described.

As shown in FIG. 7, the acquisition unit 114a acquires the position information indicating the current position of each vehicle 10 in the alignment formed by the plurality of vehicles 10 after each of the plurality of vehicles 10 is stopped at the arrangement position included in the arrangement position information generated by the generation unit 114e (step S201).

Next, the determination unit 114c determines whether the plurality of vehicles 10 are respectively stopped at the arrangement positions R₁ to Rₙ, based on the position information of each vehicle 10 acquired by the acquisition unit 114a and the arrangement position information generated by the generation unit 114e (step S202). In a case where it is determined by the determination unit 114c that the plurality of vehicles 10 are respectively stopped at the arrangement positions R₁ to Rₙ allocated to each of them (step S202: YES), the vehicle 10 proceeds to step S203 described below. On the other hand, in a case where it is determined by the determination unit 114c that the plurality of vehicles 10 are not respectively stopped at the arrangement positions R₁ to Rₙ allocated to each of them (step S202: NO), the vehicle 10 proceeds to step S204 described below.

In step S203, the ECU 114 starts power supply (discharging) from each vehicle 10 electrically connected to the C/D device 20 to the public facility 40 by establishing V2V communication via the external communication unit 111. The vehicle 10 terminates this process after step S203.

In step S204, the output control unit 114g outputs a warning indicating that the plurality of vehicles 10 are not respectively stopped at the arrangement positions R₁ to Rₙ, according to the arrangement position information P1, to the display unit 112e of each of the plurality of vehicles 10 or the master vehicle 10, or alternatively, to the communication terminal 50 associated with the master vehicle 10.

The determination unit 114c determines whether an instruction signal to instruct discharging has been input via the input unit 112d within a predetermined time (for example, within 10 minutes) (step S205). In a case where it is determined by the determination unit 114c that the instruction signal to instruct discharging has been input via the input unit 112d within the predetermined time (step S205: YES), the vehicle 10 proceeds to step S206 described below. On the other hand, in a case where it is determined by the determination unit 114c that the instruction signal to instruct discharging has not been input via the input unit 112d within the predetermined time (step S205: NO), the vehicle 10 returns to step S201.

In step S206, the ECU 114 starts power supply (discharging) from each vehicle 10 electrically connected to the C/D device 20 to the public facility 40 by establishing V2V communication via the external communication unit 111. In such a case, it is possible to prevent wasting time rearranging the arrangement positions R₁ to Rₙ of the vehicles 10 when an emergency situation is expected.

The acquisition unit 114a acquires the SOC of the secondary battery 101, the remaining amount of fossil fuel or hydrogen fuel, and the vehicle model information, of each vehicle 10, by establishing V2V communication with the slave vehicles 10 via the external communication unit 111, and also acquires the facility information indicating the number of outlets from C/D device 20 (step S207).

The calculation unit 114d calculates the power supply amount that can be supplied from each vehicle 10 to the outside, based on the SOC of the secondary battery 101, the remaining amount of fossil fuel or hydrogen fuel, and the vehicle model information, of each vehicle 10, which are acquired by the acquisition unit 114a (step S208).

The generation unit 114e generates renewed arrangement position information by which a position is allocated to each waiting vehicle 10 that is not discharging, based on the power supply amount of each vehicle 10 calculated by the calculation unit 114d, the facility information, and the vehicle model information (step S209).

The planning unit 114f generates renewed power supply plan information for each vehicle 10, based on the arrangement position information generated by the generation unit 114e, as well as the SOC of the secondary battery 101, the remaining amount of fossil fuel or hydrogen fuel, and the vehicle model information, of each vehicle 10, which are acquired by the acquisition unit 114a (step S210)

The output control unit 114g then outputs the arrangement position information generated by the generation unit 114e and the power supply plan information planned by the planning unit 114f to the slave vehicles 10, or the communication terminal 50 associated with each slave vehicle 10, by establishing V2V communication with the slave vehicles 10 via the external communication unit 111 (step S211). The vehicle 10 terminates this process after step S211.

According to the first embodiment described above, the ECU 114 acquires the SOC (charging rate) of the secondary battery 101 and the vehicle model information from each of the plurality of vehicles 10₁ to 10ₙ. The ECU 114 generates the arrangement position information by which positions are allocated to the plurality of vehicles 10₁ to 10ₙ in a case where the plurality of vehicles 10₁ to 10ₙ supply the power to the outside in parallel to each other, based on the SOC of the secondary battery 101 and the vehicle model information. The ECU 114 then outputs the arrangement position information. Accordingly, it is possible to present the arrangement position of each vehicle 10 when each of the plurality of vehicles 10₁ to 10ₙ supplies power to the external load device 43.

According to the first embodiment, the ECU 114 determines whether each vehicle 10 has the power generation function capable of supplying power to the secondary battery 101 using the predetermined fuel based on the vehicle model information, and acquires the information indicating remaining amount of the predetermined fuel from the vehicle 10 having the power generation function. After that, the ECU 114 generates the arrangement position information based on the SOC and the remaining amount of the predetermined fuel of each vehicle 10. Accordingly, it is possible to present the arrangement position of each vehicle 10 in consideration of the power generation function of the vehicle 10.

According to the first embodiment, the ECU 114 determines whether the predetermined fuel of each vehicle 10 having the power generation function is a fossil fuel, based on the vehicle model information, and generates the arrangement position information such that the vehicles 10 having the fossil fuel as the predetermined fuel are arranged in order starting from the outside of the alignment formed by the plurality of vehicles 10₁ to 10ₙ. Consequently, it is possible to prevent carbon monoxide poisoning caused by driving the engine in a case where the power is supplied from the vehicle 10 to the public facility 40.

Further, according to the first embodiment, the ECU 114 calculates the power supply amount that each of the plurality of vehicles 10₁ to 10ₙ can supply to the outside, based on the SOC and the remaining amount of fossil fuel or hydrogen fuel of each vehicle 10, and generates the arrangement position information based on the power supply amount. Accordingly, it is possible to present an arrangement position of each vehicle 10 which can minimize the burden of replacing the vehicles 10, since the arrangement position information can be generated in consideration of the power supply amount plus the power generated by the vehicle 10 in a case where the power is supplied from the vehicles 10 to the public facility 40.

According to the first embodiment, the ECU 114 generates the arrangement position information such that the vehicles 10 with a lower power supply amount are arranged in order starting from the outside of the alignment formed by the plurality of vehicles 10₁ to 10ₙ. Consequently, it is possible to present an arrangement position of each vehicle 10 which can minimize the burden of replacing the vehicles 10.

According to the first embodiment, the ECU 114 generates the power supply plan information indicating the scheduled supply times of the plurality of vehicles 10₁ to 10ₙ based on the power supply amount of each vehicle 10, and outputs the power supply plan information. Therefore, the user of each vehicle 10 can acknowledge the scheduled supply time at the arrangement position presented for the vehicle 10.

According to the first embodiment, the ECU 114 acquires the facility information including the number of outlets in the facility to which at least the plurality of vehicles 10₁ to 10ₙ supply power, and a cable grade of the C/D cable 30 connecting the outlet with each of the plurality of vehicles 10₁ to 10ₙ. The ECU 114 can present the optimum arrangement position of each vehicle 10 for the C/D device 20, since the arrangement position information is generated based on the power supply amount of each vehicle 10 and the facility information.

According to the first embodiment, the ECU 114 outputs the arrangement position information to the display unit 112e in each of the plurality of vehicles 10₁ to 10ₙ and the communication terminal 50 associated with each of the plurality of vehicles 10₁ to 10ₙ. Consequently, the user of each vehicle 10 can intuitively understand the arrangement position of their own vehicle.

According to the first embodiment, in a case where the plurality of vehicles 10₁ to 10ₙ are stopped at their arrangement positions, the ECU 114 acquires the position information indicating the current position of each vehicle 10 in the alignment formed by the plurality of vehicles 10₁ to 10ₙ. The ECU 114 then determines whether each of the plurality of vehicles 10₁ to 10ₙ is stopped at its arrangement position based on the arrangement position information and the position information. Upon determining that each of the plurality of vehicles 10₁ to 10ₙ is not stopped at its arrangement position, the ECU 114 outputs information indicating that each vehicle 10 is not stopped at its arrangement position. Therefore, it is possible to prevent wasting time rearranging the arrangement positions R₁ to Rₙ of the vehicles 10.

According to the first embodiment, upon determining that each of the plurality of vehicles 10₁ to 10ₙ is not stopped at its arrangement position after each of the plurality of vehicles 10₁ to 10ₙ starts to supply power, the ECU 114 generates arrangement position information which is updated by allocating a new position to each of the plurality of vehicles 10₁ to 10ₙ after power supply of the vehicle 10 with the lowest SOC is ended, among the plurality of vehicles 10₁ to 10ₙ which are supplying power, and then outputs the updated arrangement position information. Consequently, it is possible to prevent wasting time rearranging the arrangement positions R₁ to Rₙ of the vehicles 10.

### Second Embodiment

A second embodiment will be described hereinbelow. In the first embodiment, each vehicle 10 acquires the SOC of the secondary battery 101, the remaining amount of fossil fuel or hydrogen fuel, and the vehicle model information by establishing V2V communication. On the other hand, in the second embodiment, a server acquires the SOC of the secondary battery 101, the remaining amount of fossil fuel or hydrogen fuel, and the vehicle model information from each vehicle 10 via a network, and generates the arrangement position information by which an arrangement position is allocated to each of the plurality of vehicles 10. The same components as those of the power system 1 according to the first embodiment are denoted by the same reference numerals, and detailed description thereof will be omitted hereinbelow.

Outline Configuration of Power System

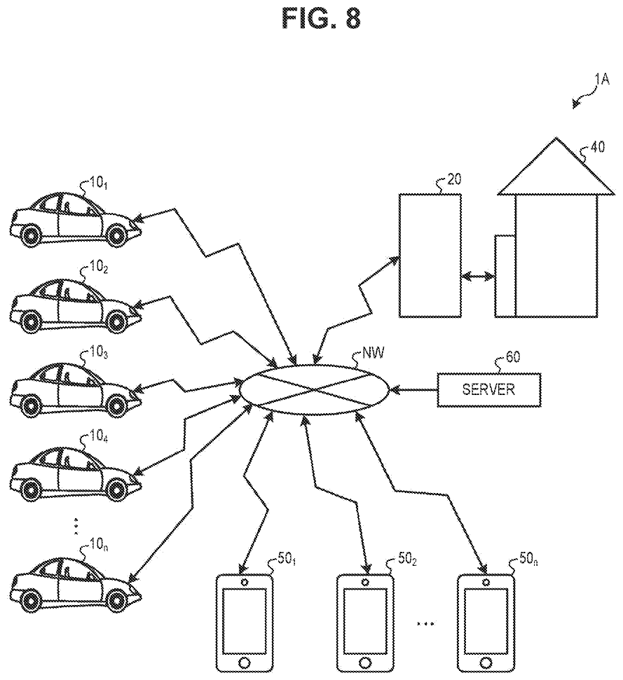

FIG. 8 is a diagram illustrating a schematic configuration example of a power system according to the second embodiment. A power system 1A shown in FIG. 8 further includes a server 60 capable of establishing communication with the plurality of vehicles 10₁ to 10ₙ, the C/D device 20, and the plurality of communication terminals 50₁ to 50ₘ via a network NW, in addition to the configuration of the power system 1 according to the first embodiment. The network NW includes, for example, the Internet or a mobile phone network.

Functional Configuration of Server

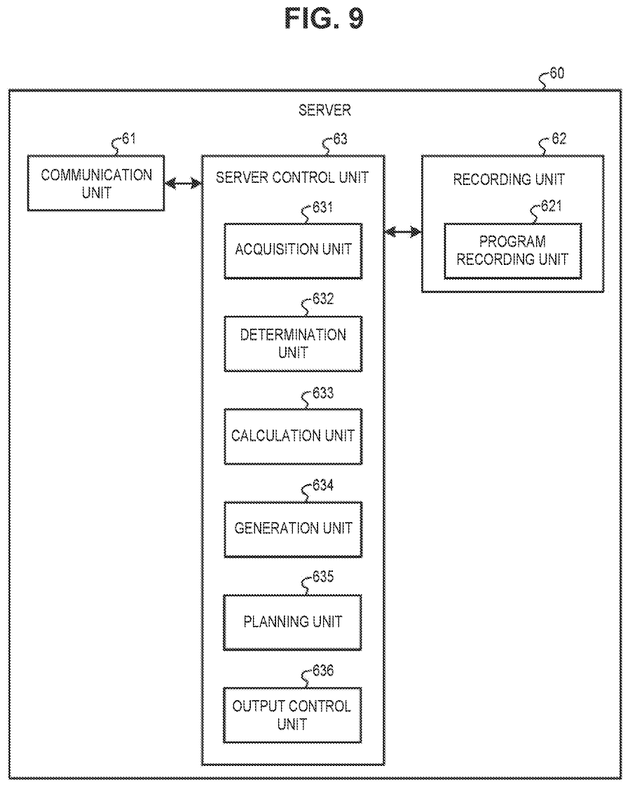

A functional configuration of the server 60 will be described hereinbelow. FIG. 9 is a block diagram illustrating the functional configuration of the server 60.

As illustrated in FIG. 9, the server 60 includes a communication unit 61, a recording unit 62, and a server control unit 63.

The communication unit 61 receives various information from the plurality of vehicles 10₁ to 10ₙ, the C/D device 20, and the plurality of communication terminals 50₁ to 50ₘ via the network NW, as controlled by the server control unit 63. The communication unit 61 transmits various information to the plurality of vehicles 10₁ to 10ₙ, the C/D device 20, and the plurality of communication terminals 50₁ to 50ₘ, as controlled by the server control unit 63. The communication unit 61 includes, for example, a wireless communication module capable of transmitting and receiving various information.

The recording unit 62 records various information on the server. The recording unit 62 has a program recording unit 621 recording various programs executed by the server 60. The recording unit 62 includes, for example, a DRAM, a ROM, a flash memory, a hard disk drive (HDD), or a solid state drive (SSD).

The server control unit 63 controls each unit constituting the server 60. The server control unit 63 includes a memory and a processor having hardware such as a CPU. The server control unit 63 has the same functions as the ECU 114 of the vehicle 10, and includes an acquisition unit 631, a determination unit 632, a calculation unit 633, a generation unit 634, a planning unit 635, and an output control unit 636. In the second embodiment, the server control unit 63 functions as the control device.

The acquisition unit 631 acquires the SOC (charging rate) of the secondary battery 101 from each of the plurality of vehicles 10₁ to 10ₙ via the communication unit 61. Further, in a case where the vehicle 10 determines whether each vehicle 10 has a power generation function capable of supplying power to the secondary battery 101 using a predetermined fuel based on the vehicle model information of the vehicle 10, and has the power generation function, the acquisition unit 631 acquires a remaining amount of fossil fuel or hydrogen fuel from the vehicle 10 having the power generation function via the communication unit 61.

The determination unit 632 determines whether fossil fuel is used in the vehicle 10 having the power generation function capable of supplying power to the secondary battery 101 using the predetermined fuel, based on the vehicle model information acquired by the acquisition unit 631. Further, the determination unit 632 determines whether the plurality of vehicles 10 are respectively stopped at arrangement positions R₁ to Rₙ, based on the position information of each vehicle 10 acquired by the acquisition unit 631 and arrangement position information generated by the generation unit 634.

The calculation unit 633 calculates the power supply amount (Wh) that can be supplied from each vehicle 10 to the outside, based on the SOC of the secondary battery 101, the remaining amount of fossil fuel or hydrogen fuel, and the vehicle model information, of each vehicle 10, which are acquired by the acquisition unit 631.

The generation unit 634 generates the arrangement position information by which a position is allocated to each of the plurality of vehicles 10₁ to 10ₙ, based on the power supply amount of each vehicle 10 calculated by the calculation unit 633, the facility information, and the vehicle model information. In such a case, the generation unit 634 generates the arrangement position information such that the vehicles 10 whose fuel is fossil fuel are arranged in order starting from the outside of an alignment formed by the plurality of vehicles 10₁ to 10ₙ. Further, the generation unit 634 generates the arrangement position information such that the vehicles 10 with a lower power supply amount are arranged in order starting from the outside of the alignment formed by the plurality of vehicles 10₁ to 10ₙ.

The planning unit 635 generates power supply plan information indicating the scheduled supply time of each vehicle 10, based on the arrangement position information generated by the generation unit 634, as well as the SOC of the secondary battery 101, the remaining amount of fossil fuel or hydrogen fuel, and the vehicle model information, of each vehicle 10, which are acquired by the acquisition unit 631.

The output control unit 636 outputs the arrangement position information generated by the generation unit 634 and the power supply plan information planned by the planning unit 635 to each vehicle 10 or the communication terminal 50 associated with each vehicle 10, by establishing communication with each vehicle 10 via the communication unit 61.

Processing in Server

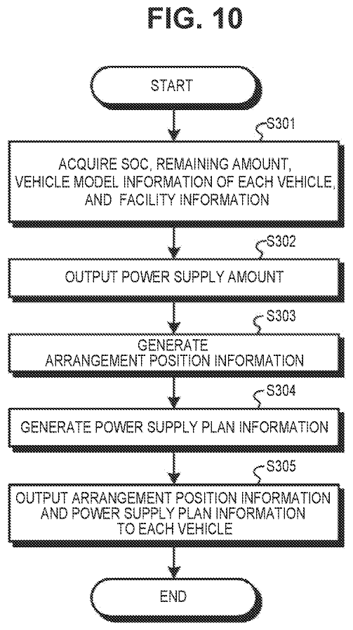

An arrangement position presentation process executed by the server 60 will be described hereinbelow. FIG. 10 is a flowchart illustrating an outline of the arrangement position presentation process executed by the server 60.

As shown in FIG. 10, the acquisition unit 631 acquires the SOC of the secondary battery 101, the remaining amount of fossil fuel or hydrogen fuel, and the vehicle model information, of each vehicle 10, via the communication unit 61, and further, acquires the facility information from the C/D device 20 (step S301). Further, the determination unit 632 determines whether each vehicle 10 has the power generation function capable of supplying power to the secondary battery 101 using the predetermined fuel based on the vehicle model information. The acquisition unit 631 acquires the remaining amount of fossil fuel or hydrogen fuel from the vehicle 10 having the power generation function, which is determined by the determination unit 632.

The calculation unit 633 calculates the power supply amount that can be supplied from each vehicle 10 to the outside, based on the SOC of the secondary battery 101, the remaining amount of fossil fuel or hydrogen fuel, and the vehicle model information, of each vehicle 10, which are acquired by the acquisition unit 631 (step S302).

The generation unit 634 generates the arrangement position information by which a position is allocated to each of the plurality of vehicles 10₁ to 10ₙ, based on the power supply amount of each vehicle 10 calculated by the calculation unit 633 and the facility information and the vehicle model information of each vehicle 10 acquired by the acquisition unit 631 (step S303).

The planning unit 635 generates power supply plan information of each vehicle 10, based on the arrangement position information generated by the generation unit 634, as well as the SOC of the secondary battery 101, the remaining amount of fossil fuel or hydrogen fuel, and the vehicle model information, of each vehicle 10, which are acquired by the acquisition unit 631 (step S304).

The output control unit 636 outputs the arrangement position information generated by the generation unit 634 and the power supply plan information (for example, see FIG. 6) planned by the planning unit 635 to each vehicle 10 or the communication terminal 50 associated with each vehicle 10, via the communication unit 61 (step S305). Consequently, the user of each vehicle 10 can intuitively understand the arrangement position and the scheduled supply time of their own vehicle.

According to the second embodiment described above, like the first embodiment, it is possible to present the arrangement position of each vehicle 10 when each of the plurality of vehicles 10₁ to 10ₙ supplies power to the external load device 43.

In the second embodiment, the server control unit 63 may execute the power supply process of FIG. 7 after each vehicle 10 stops at the arrangement position according to the arrangement position information.

In the second embodiment, the server control unit 63 generates and outputs the arrangement position information and the power supply plan information of each vehicle 10 to each vehicle 10 via the network NW. However, the functions of the server control unit 63 may be implemented by the C/D control unit 25 so as to serve as the control device. In other words, the C/D control unit 25 may include the acquisition unit 631, the determination unit 632, the calculation unit 633, the generation unit 634, the planning unit 635, and the output control unit 636, and may execute the processing shown in FIG. 10. Consequently, even if communication failure occurs in, for example, the network NW, the arrangement position information and the power supply plan information of each vehicle 10 can be output within the public facility 40, and thus the user of each vehicle 10 can intuitively understand the arrangement position and the scheduled supply time of their own vehicle. The C/D control unit 25 may execute the power supply process of FIG. 8 after each vehicle 10 stops at the arrangement position according to the arrangement position information.

### Other Embodiments

Further, the “units” in the first and second embodiments can be interpreted as “circuits” or the like. For example, the control unit can be interpreted as a control circuit.

Further, the program to be executed by the power system according to the first or second embodiment is file data in an installable or executable format, which is provided as being recorded in a computer-readable recording medium, such as a CD-ROM, flexible disk (FD), CD-R, DVD (digital versatile disk), USB, or flash memory.

Furthermore, the program to be executed by the power system according to the first or second embodiment may be stored on the computer connected to a network such as the Internet and provided by downloading via the network.

In the description of the flowchart in the present specification, the context of the relationship between steps has been clarified by using expressions such as “after”, “then”, and “subsequently”, but the order of steps to implement the present embodiment is not uniquely defined by those expressions. In other words, the order of processes in the flowchart described in the present specification can be changed if no contradiction or conflict occurs.

Further advantageous effects and modifications can be easily appreciated by those skilled in the art. The aspects of the present disclosure are not limited to the specific details and representative embodiments illustrated and described above. Accordingly, various modifications may be made without departing from the spirit or scope of the general inventive concept as defined by the following claims and their equivalents.

What is claimed is:

1. A control device comprising:
a processor configured to:
acquire, from each of a plurality of vehicles having a secondary battery and being configured to supply power to an outside, information indicating a charging rate of the secondary battery and vehicle model information indicating vehicle models of the vehicles;
generate arrangement position information by which a arrangement position is allocated to each of the plurality of vehicles in a case where the plurality of vehicles supply the power to the outside in parallel to each other, based on the charging rate and the vehicle model information; and
output the arrangement position information.

2. The control device according to claim 1, wherein the processor is configured to:
determine whether each of the plurality of vehicles has a power generation function by which power is supplied to the secondary battery using a predetermined fuel, based on the vehicle model information;
acquire information indicating a remaining amount of the predetermined fuel from a vehicle having the power generation function; and
generate the arrangement position information based on the charging rate and the remaining amount.

3. The control device according to claim 2, wherein the processor is configured to:
determine whether the predetermined fuel is a fossil fuel based on the vehicle model information; and
generate the arrangement position information such that vehicles having the fossil fuel as the predetermined fuel are arranged in order starting from the outside of an alignment formed by the plurality of vehicles.

4. The control device according to claim 2, wherein the processor is configured to:
calculate a power supply amount that each of the plurality of vehicles supplies to the outside based on the charging rate and the remaining amount; and
generate the arrangement position information based on the power supply amount.

5. The control device according to claim 4, wherein the processor is configured to generate the arrangement position information such that vehicles with a lower power supply amount are arranged in order starting from the outside of an alignment formed by the plurality of vehicles.

6. The control device according to claim 4, wherein the processor is configured to:
generate power supply plan information indicating a scheduled supply time of each of the plurality of vehicles, based on the power supply amount; and
output the power supply plan information.

7. The control device according to claim 4, wherein the processor is configured to:
acquire facility information at least including the number of outlets in a facility supplied by each of the plurality of vehicles, and a cable classification of charging-discharging cables connecting the plurality of vehicle to the outlets, respectively; and
generate the arrangement position information based on the power supply amount and the facility information.

8. The control device according to claim 1, wherein the processor is configured to output the arrangement position information to a display monitor included in each of the plurality of vehicles, and a communication terminal associated with each of the plurality of vehicles.

9. The control device according to claim 1, wherein the processor is configured to:
acquire, in a case where each of the plurality of vehicles is stopped at the arrangement position, position information indicating a current position of each vehicle in an alignment formed by the plurality of vehicles;
determine whether each of the plurality of vehicles is stopped at the arrangement position based on the arrangement position information and the position information; and
output, upon determining that each of the plurality of vehicles is not stopped at the arrangement position, information indicating that each of the plurality of vehicles is not stopped at the arrangement position.

10. The control device according to claim 9, wherein the processor is configured to:
generate, upon determining that each of the plurality of vehicles is not stopped at the arrangement position after each of the plurality of vehicles starts to supply power, arrangement position information which is updated by allocating a new position to each of the plurality of vehicles after power supply of a vehicle with a lowest charging rate is ended, from among the plurality of vehicles which are supplying power; and
output the updated arrangement position information.

11. The control device according to claim 1, wherein:
the control device is mounted on any of the plurality of vehicles, and
the processor is configured to acquire the information indicating the charging rate and the vehicle model information by vehicle-to-vehicle communication.

12. The control device according to claim 1, wherein the control device is mounted on a server configured to communicate with each of the plurality of vehicles via a network.

13. The control device according to claim 1, wherein the control device is mounted on a charging-discharging device configured to charge each of the plurality of vehicles and supply power to each of the plurality of vehicles.

14. A power system comprising:
a plurality of vehicles, each of which has a secondary battery and is configured to supply power to an outside; and
a control device configured to communicate with each of the plurality of vehicles, wherein
the control device includes a processor configured to:
acquire, from each of the plurality of vehicles, information indicating a charging rate of the secondary battery and vehicle model information indicating vehicle models of the vehicles;
generate arrangement position information by which a arrangement position is allocated to each of the plurality of vehicles in a case where the plurality of vehicles supply the power to the outside in parallel to each other, based on the charging rate and the vehicle model information; and
output the arrangement position information.

15. A program causing a processor to execute:
acquiring, from each of a plurality of vehicles having a secondary battery and being configured to supply power to an outside, information indicating a charging rate of the secondary battery and vehicle model information indicating vehicle models of the vehicles;
generating arrangement position information by which a arrangement position is allocated to each of the plurality of vehicles in a case where the plurality of vehicles supply the power to the outside in parallel to each other, based on the charging rate and the vehicle model information; and
outputting the arrangement position information.
